(19) United States
(12) Patent Application Publication
(10) Pub. No.: US 2014/0358817 A1
(43) Pub. Date: Dec. 4, 2014

(54) AUTOMATED PROJECT DESIGN OF A CONTROL TECHNOLOGY FOR A TECHNICAL SYSTEM

(71) Applicant: Seimens Aktiengesellschaft, Munich (DE)

(72) Inventor: Klaus Wendelberger, St. Leon-Rot (DE)

(73) Assignee: SIEMENS AKTIENGESELLSCHAFT, Munich (DE)

(21) Appl. No.: 14/367,907

(22) PCT Filed: Dec. 19, 2012
(86) PCT No.: PCT/EP2012/076070

§ 371 Date: Jun. 21, 2014

(30) Foreign Application Priority Data
Dec. 23, 2011 (DE) 10 2011 089 892.1

(51) Int. Cl. G06Q 10/10; G06F 17/21; G05B 15/02

(52) U.S. Cl. CPC G06Q 10/10; G05B 15/02; G06F 17/211
USPC 705/342

(57) ABSTRACT

A method for producing a system-specific project design document for control technology to be project-designed for a technical system as well as a device designed for the implementation of the method is provided. A reference project design document for the technical system is produced. Through a comparison of a project-specific project design document for the technical system the reference project design document, performed using a comparison marking, wherein the project-specific project design document is created using standard project design objects, the system-specific project document is created.

### CROSS REFERENCE TO RELATED APPLICATIONS

This application is the U.S. National Stage of International Application No. PCT/EP2012/076070 filed Dec. 19, 2012, and claims the benefit thereof. The International Application claims the benefit of German Application No. DE 102011089892.1 filed Dec. 23, 2011. All of the applications are incorporated by reference herein in their entirety.

### FIELD OF INVENTION

The invention relates to a method for generating a system-specific project design document, in particular for generating a system-specific functional plan, for a control technology to be project-designed for a technical system, and also a device implemented to carry out the method.

### BACKGROUND OF INVENTION

A control technology, in this case a process control technology, of a system typically refers to means and methods which are used for controlling, regulating, and securing such a process or method system.

Project design is conventionally understood as a preparation of an event, a process, or a real construct. In the field of process technology and process automation, the term project design is used for the preparation of technical (or other) documents for a system to be project-designed.

Such project design documents are, for example:—Functional plans of controllers and regulators (controller functional plan, regulator functional plan), in which it is shown which measured variables are used in a system and how these are algorithmically processed to ascertain how drives, valves, flaps, motors, inter alia, of the system are to be moved;—operating menus, via which a system operator receives items of information about a current state of a system, for example, displays, and via which the system operator can perform control actions, such as operating elements;—descriptions, in which functionalities of the system and of automation functions of the system are verbally explained.

Such a project design document itself is in turn generally constructed from multiple elements which are related or linked to one another, and which are to be referred to hereafter as so-called project design objects.

For example, such a project design object can be a (functional) module (with/without linkages, in particular connections, to other modules) of a functional plan, or a linkage itself in a functional plan, a graphic element of an operating menu or of an operating interface, or a text module of a description.

A project design of higher-quality control-technology functions in process automation is fundamentally very complex and susceptible to errors.

An efficient method for reducing an expenditure during the project design or for preparation of such project design documents and for improving quality is standardization.

In the scope of a standardization or the use of standards, saving or storing such standards accordingly is also known, for example, in libraries, archives, databanks, inter alia—which is also possible in various forms, such as on paper or electronically—where they are available to a user, for example, a project engineer, via an access.

A repeated use of a standard during the project design or for a project design document, such as for a functional plan, an operating menu, or a description, ensures that—on the one hand, the corresponding project design expenditure is significantly reduced, since an already existing (standard) template can be used,—and, on the other hand, the quality of the project design is significantly increased, since (standard) documents can be used, which have already proven themselves in multiple projects.

Method systems differ, however, in their specific method and/or design construction (layout of the systems for different operating points and operating modes, other producers for individual system components, inter alia). In addition, specific, different requirements are placed on the respective system by the customer.

This requires that—either defined standards are to be adapted again and again to the respective specific requirements of a specific project, i.e., a system to be project-designed, or—various variants are to be prepared for each standard, using which then project-specific requirements for a system can be fulfilled directly at least in large part.

A manual adaptation of a standard to the respective project-specific requirements is still always connected to a substantial expenditure and a corresponding susceptibility to error.

In addition, the project engineer must have excellent technological and control-technology know-how, to be able to perform the project-specific changes correctly.

In contrast, if various variants are used for each standard, a set of problems exists in managing a variant diversity.

If one generates a separate standard for each possible variant, which is defined by the project-specific, method construction of the respective system and the respective specific customer requirement, this leads directly to an inflation of standards. This results in further disadvantages such as:—During the project-specific project design, the project engineer must search out the correct variant from a plurality of standards. This operation is already again connected to a substantial expenditure and probability of error.—The project engineer must additionally be very familiar with “his” standards as an expert, i.e., he must be very familiar with the library, the archive, or the databank of the standards.—Errors may also occur for him during the project-specific selection of the standards.—A plurality of standards prevents continuous maintenance and care of the standards or the library, the archive, or the databank from being able to be performed.—Standard libraries, archives, or databanks, in which the present state of the knowledge is not stored, or standards which do not reflect the present state of the knowledge, and which even frequently have errors or do not match with one another, are, however, correctly rejected by the project engineers.

Notwithstanding this, standards, if one wishes to also comprehend nearly all possible variants oneself, cannot ensure complete coverage of systems to be project designed, not least because of the method variety and specifications of plants. A remainder of “manual reworking” of system-specific project design documents generated from standards remains necessary.

### SUMMARY OF INVENTION

The invention is based on the object of providing a method and a device, using which a project design of a technical system, in particular a preparation of a project design document, for example, a functional plan, for a control technology of a technical system, can be carried out with little expenditure and less susceptibility to error. Furthermore, the invention is based on the object of improving the above-mentioned disadvantages in the prior art.

The object is achieved by the method for generating a system-specific project design document, in particular for generating a system-specific functional plan, for a control technology to be project-designed for a technical system, and also a corresponding device for generating a system-specific project design document, in particular for generating a system-specific functional plan, for a control technology to be project-designed of a technical system having the features according to the respective independent patent claim.

A project design document—in general and especially in the meaning according to the invention, for example, as a reference or project-specific project design document—can be in this case—a functional plan, in particular a regulator functional plan (in brief also only regulating functional plan), or a controller functional plan of a component, for example, of a drive, a valve, a flap, a motor, inter alia, of a technical system,—an operating interface (operating menu) for a technical system, and/or—a description, in particular a text description, of a technical system, in particular a description of a functionality of a technical system.

Such a project design document itself can in turn be constructed from in general multiple elements which are connected or linked to one another, and which are to be referred to hereafter as so-called project design objects.

Thus, for example, such a project design object can be—a (functional) module (with/without linkages, in particular connections to other modules) and/or an object of a functional plan,—a linkage or a linkage line and/or a (partial) structure in a functional plan and/or between (functional) modules,—a graphic element of an operating menu or operating interface, or—a text module of a description.

According to the method according to the invention, a reference project design document—having corresponding project design objects—is generated for the technical system. The project design objects of this reference project design document can also be referred to hereafter—in particular for more precise assignment—as reference project design objects.

In this case, the term “reference”—in the project design document—and in associated project design objects—expresses the fact that these project design documents or project design objects are to be used for a comparison to other project design documents or project design objects, in particular equivalent in type or species and/or structure. Transformations of the project design documents to be compared into comparable or corresponding data structures can optionally be provided here.

Such reference project design documents can be, for example, in the case of modernization projects of technical systems, functional plans of the control-technology old system or, in the case of new construction projects, functional specifications of the producer of the method system.

Such a reference project design document can also be prepared by digital image processing from a predefined document, for example, a project design document provided in paper form, and/or by analyzing digital image information (digital image recognition), in particular by analyzing the predefined document processed by the digital image processing.

Expressed simply, for example, a reference (functional) plan, which is provided in paper form, of a technical system can be scanned and a graphic file can thus be generated. This graphic file is further processed with the aid of automatic image recognition, whereby project design objects, i.e., the reference project design objects, can be identified in the reference project design document.

To improve this digital image processing and image recognition, it can furthermore be provided that the digital information or the digitized image is filtered. Interference and/or noise may thus be removed from the digitized image.

A symbol library, in which predefined project design objects, in particular project design objects of various reference control technologies are stored, can also be used in the digital image recognition, on the basis of which symbol library the reference project design document can be analyzed and project design objects—of the reference project design document—can be identified in the digitized image.

The reference project design document can also be generated by reading in digital information or data.

Furthermore, in the invention, a comparison of a project-specific project design document, which is prepared—using standard project design objects—, of the technical system to the reference project design document is carried out.

A standard project design object is to be understood in this case to mean that such an object is valid for a variety (“maximum variant”) of functionalities of technical systems—for which control technologies are to be project-designed.

This can preferably be implemented such that optional (functional) modules and/or objects of a functional plan, optional linkages and/or structures/partial structures in a functional plan, optional graphic elements of an operating menu, and/or optional text modules of a description are predefined.

In brief, with the use of standards, i.e., the standard project design objects, a project-specific project design document is prepared, which is then compared to the reference project design document.

Project design objects of this project-specific project design document can also be referred to hereafter—in particular for more precise assignment—as project-specific project design objects.

The preparation of the project-specific project design document from the or with use of the standard project design objects is to be understood in particular to mean that the project-specific project design document—having the—then project-specific project design objects—is generated or “assembled” for the system from the standard project design objects—by adaptation to the system to be project-designed.

A specific description of the technical system to be project-designed can be used for the adaptation in this case.

Such a specific description of the system for which the control technology is to be project-designed can contain one or more items of information on this system. In other words, a configuration (variant) of a—defined—system to be project-designed is defined via the—specific—description.

Such an item of information or description can be, for example, a requirement or requirement specification for the system, a boundary condition for the system, a function of the system, a technical construction of the system, a technical component of the system, titles of components of the system, or similar characteristics of the technical system.

Visually expressed, the project-specific project design document is automatically “assembled” from the standard project design objects, wherein during the “assembly”, (project-) specific specifications from a specific description of the system to be project-designed can be taken into consideration.

The system-specific project design document according to the invention is then prepared by the comparison—between project-specific project design document and reference project design document.

Project design objects of this system-specific project design document can also be referred to hereafter—in particular for precise assignment—as system-specific project design objects.

This comparison is carried out according to the invention while using a comparison identification.

A comparison or comparison using the comparison identification in the meaning of the invention is to be understood in particular to mean that a comparison of the project-specific project design document to the reference project design document or respective project design objects from these project design documents is carried out to recognize differences or deviations between them.

On the basis of the comparison identification, it is then decided which respective project design object, i.e., the project-specific project design object or the corresponding reference project design object is accepted—as a system-specific project design object—in the system-specific project design document and thus the system-specific project design document is prepared.

Expressed briefly or simply, it is established via the comparison identification whether the standard, which is reflected in the project-specific project design document—by project-specific adaptation—or the reference is to be accepted—in the system-specific project design document.

Therefore, such a comparison identification can generally be understood as an item of rank information, via which, for example, a superiority or inferiority of a standard project design object—or then accordingly therefore a project-specific project design object—is established in relation to a (corresponding) reference project design object.

The comparison can preferably be performed under the following principles:—As much as possible, “standards” are to be accepted, since in this way the advantages achieved by a standardization can be used.—Where necessary, the “references” are to be accepted, since standards cannot completely cover system configurations down to the smallest detail and system-specific specifications, for example, of the system-technical producer, which lie outside the standards are to be considered.

The device according to the invention has a data processing device, in particular a programmed computing unit, which is configured such that the following steps can be carried out:—generating a reference project design document of the technical system,—preparing the system-specific project design document—by a comparison, which is carried out using a comparison identification, of a project-specific project design document, which is prepared using standard project design objects, of the technical system to the reference project design document.

The device is particularly suitable for carrying out the method according to the invention or one of its refinements explained hereafter.

The invention therefore primarily proceeds from the use of standards or of standardized project design objects, which are adapted to the project-specific configuration of a technical system.

In this way, the invention ensures that:—for a variety of various projects, matching standards can always be provided, wherein simultaneously;—the selection and project-specific adaptation of the matching standards can be carried out rapidly and easily by a user and;—simple ability to maintain and care for the standards is provided.

The invention therefore achieves the following advantages:—cost reduction in the project design by automatic generation of project-specific project design documents;—cost reduction during putting into operation by repetition of already known standards;—increase of the quality by repeated use of already tested and error-corrected structures;—high conformity to the specific system by the selection of the required variant of the standard.

The invention then further proceeds from the consideration that the standard adapted to the respective project-specific requirements nonetheless cannot completely cover—though it can substantially cover—the respective system-specific requirements, for example, predefined by a method supplier.

For this purpose, the invention then provides the comparison of the project-specific project design document to the reference project design document, which can contain such system-specific requirements of a method supplier.

Therefore, the invention achieves a high conformity in the prepared system-specific project design document. I.e., it matches exactly with the system configuration.

Specifications, for example, those of the method producer of a system, can thus also be implemented automatically and completely.

The invention accordingly proves to be particularly advantageous in many aspects.

The invention combines, on the one hand, the advantages of a standardization with, on the other hand, the possibility, where standards no longer apply and/or producer-specific specifications must be considered, of being able to easily implement these in a system-specific manner.

The procedure according to the invention is also automatable. Thus, a substantial cost reduction in the project design can be achieved by the invention based on this automatable procedure. The quality of the project design may also be increased based on the automated procedure, in particular on the basis of tested structures.

Preferred refinements of the invention also result from the dependent claims.

The described refinements relate both to the method and also to the device.

The invention and the described refinements can be implemented both in software and also in hardware, for example, using a special electrical circuit.

Furthermore, an implementation of the invention or a described refinement is possible by way of a computer-readable storage medium, on which a computer program is stored, which executes the invention or the refinement.

The invention and/or any described refinement can also be implemented by a computer program product, which has a storage medium, on which a computer program is stored, which executes the invention and/or the refinement.

### SPECIFIC DESCRIPTION

The generation of the specific description, in particular for selecting and/or adapting the standard project design objects, can preferably be generated from direct or indirect user inputs, for example, by directly specifying information, by answering yes/no questions, by multiple-choice specifications of a user, or by inputting analog numeric values.

Reading in information, in particular automated reading in of information via an interface, can also be such a generation. A generation also comprises accessing already existing information, in particular information stored in centralized or decentralized form.

The generated specific description of the system can be generated or provided in this case while using or in the form of an (acquisition) list, for example, a (variant) definition list and/or a function list.

Via such a variant definition list, for example, the specific construction of a method system (for example, boiler type of the power plant system, number of assemblies, inter alia) and/or customer-specific requirements to be fulfilled (for example, customer of the VGB market) can be defined.

Via such a function list, for example, by an identification or an identifier, the specific project design document or a project design object belonging thereto, which is to be generated—from the standard—can be—uniquely—assigned to a method component of the system to be project designed, such as an assembly.

In particular this simplified and automatic generation of the specific description, for example, by answering simple questions in project design lists by the project engineer or also automatically inputting items of information, saves time and costs.

Standard Databank and Selection of Standard Project Design Objects (with Use of the Specific Description)

According to a preferred refinement, it is provided that the standard project design objects are stored in an archive.

Such an archive is to be understood in this case very generally as availability of predefined information, in this case of the predefined standard project design objects, in arbitrary form and/or at arbitrary location—or also decentralized at arbitrary locations.

Thus, such an archive can be, for example, a library, a databank, inter alia, where the available information is available in arbitrary form, for example, on paper or also electronically.

The predefined standard project design objects are available for selection in such an archive.

Considered in simplified and illustrative form, an archive thus represents a standard databank, in which, for each project design document, a corresponding standard is predefined in an embodiment (“maximum standard”, “maximum variant”) applicable for a variety of technical systems—for which control technologies are to be project-designed. I.e., the project design objects of the project design documents are available in this maximum databank in a maximum variant, i.e., as standard project design objects—for selection and adaptation/specification.

This can preferably be implemented such that optional (functional) modules and/or objects of a functional plan, optional linkages and/or structures/partial structures in a functional plan, optional graphic elements of an operating menu, and/or optional text modules of a description are predefined.

The selection of standard project design objects from the archive—to prepare the project-specific project design document—can be performed while using the specific description of the system.

Firstly, in this case the specific description can be analyzed, whereby it is defined which standard in which variant is required in the project.

In particular via the acquisition lists, for example, via the variant definition list, it can be defined for the project design documents, i.e., for functional plans, operating menus, and descriptions, which variants of a defined standard are required in the project. The project design objects required for the project-specific project design document can then be selected from the archive in accordance with this definition.

Furthermore, it can be provided that there is respectively only a single “maximum variant” in the archive for the project design objects. The maintenance and care of the archive or the project design objects is thus substantially simplified.

The quality of the project design can furthermore be significantly increased if the project-specific project design documents are always generated from the same standard project design objects, which have been already been tested and proven themselves in a variety of systems.

Project design objects which are not required in a project-specific manner do not occur in the project-specific project design document and therefore also do not stress resources of the control system.

The specific project design document finally only contains the project design objects (in specific linkage) which are also required in the specific project and therefore remains comprehensible and able to be handled well.

Adaption of Standard to Project

During the preparation (adaptation) of the project-specific project design document from the standard project design objects—selected from the archive—the specific description and also (further) logics, in particular binary logics, and/or rules of the or “behind” the project design objects can be analyzed.

Proceeding therefrom, the adaptation (specification) of the standard project design objects for preparing the project-specific project design document can be performed in particular by—erasing, blanking out, and/or displaying structures or structural elements and/or partial structures and/or connections in functional plans, operating menus, or descriptions,—erasing, displaying, and/or blanking out parts or (partial) objects of functional plans, operating menus, or descriptions, which specifically are not required or are required,—preparing specific connections or linkages in functional plans, operating menus, or descriptions,—(re)interconnecting or transferring switches in functional plans,—(re)placing specific project design objects,—setting parameters to defined values.

The logic in the adaptation, for example, for transferring switches or for inserting and blanking out objects, can be constructed in this case as a logical linkage of one or more rules in the specific description (for example, transfer switches if rule x AND NOT rule y OR rule z=TRUE). It is also possible that transfer criteria can be derived from numeric values, which are specified in the specific description, of variables therein (for example, rule x=2, rule y>3, inter alia).

It is also conceivable to generate new structures or structural elements and/or partial structures, new objects, which are specifically required, new connections or linkages, new switches or switch connections—and to also have these incorporated in the project-specific project design document.

These “new creations” could then also be cared for in the archive—again in maximum variant. In other words, new variants of standards can be generated and saved in the databank.

In this way, current, tested standards can always be ensured. A simple ability to maintain and care for the standards is thus also provided.

The project-specific adaptation during the preparation of the project-specific project design documents can be performed automatically “at the push of a button”, without the project engineer having to concern himself as an expert with details of the (standard) project design objects in the archive. In addition, the linkage of the rules to the project design objects also offers the possibility of providing already predefined structures here.

Comparison Identification (Identification as a Core Element including Special Identification and Degree of Comparison)

According to a preferred refinement, it is provided that the predefinable comparison identification describes a rank, in particular a superiority, of a standard project design object (core object). Thus, for example—in the case of identification of a standard project design element as superior—core objects may be defined which are entered unconditionally into the system-specific project design document—from the standard (via the project-specific project design document). Such an identification for a (standard) project design object can also already be performed in the archive.

Furthermore, it is expedient to pass on this identification of standard project design objects into “successors”—generated from these standard project design objects—so that the identification is also available therein.

It can also be provided that the predefinable comparison identification describes a rank, in particular a superiority, of at least one functionality of the technical system (degree of comparison for (partial) functionalities).

Such a functionality or partial functionality can be a regulating concept, a setpoint value wiring, a feedforward control, a control concept, a protective circuit, and/or a use of nonstandardized measured variables.

Thus, for example, the superiority of standards may be defined in the case of such an affected functionality or partial functionality. I.e., for the affected functionality or partial functionality, the corresponding project design objects are accepted from the standard.

In particular, it can be provided here that the predefinable comparison identification describes the rank of multiple functionalities, for example, in (binary) coded form.

Furthermore, it can also be provided that the predefinable comparison identification is not fixed, but rather dependent—on defined parameters. Thus, for example, the rank of the standard project design object and/or the rank of the functionality can be dependent on a variant of the technical system (project-specific/adapted rank for project-specific variants of the standard).

Expressed in simplified or illustrative form, the superiority of a project design object or a functionality can be dependent on a project-specific variant of the standard.

It can also be provided that a project design object which has a specific predefinable comparison identification after the comparison identification is additionally described with a special comparison identification and the comparison is also performed using the special comparison identification.

Thus, for example, a core object can receive an additional special identification here, if it fulfills a special function, for example, a functionality, such as the setpoint value wiring or the protective circuit.

This additional special identification can also be variant-dependent. This can also already be performed in the archive.

Furthermore, it is also expedient to pass on this special identification in the case of the standard project design objects—in project-specific project design objects.

Comparison strategy, new project design objects in the system-specific project design document

Furthermore, it can be provided that in the case of the comparison, firstly all project-specific project design objects—identified as superior—i.e., project design objects in the project-specific project design document, which—identified as superior—are based on standard project design objects (passing on the identification/the rank to the project-specific project design element), are assigned to the system-specific project design document and used therein—in analogy to the standard. Thus, for example, connections between functional modules can be produced again therein in analogy to a standard functional plan.

For gaps in the system-specific project design document, respective project design objects of the project-specific project design document and the reference project design document which correspond to one another can then respectively be compared while using the comparison identification, and a respective project design object established as superior can be selected as the system-specific project design object for the gap of the system-specific project design document or accepted therein. Further gaps in the system-specific project design document can then be closed using reference project design objects.

Also, in the case of the comparison of project-specific and reference project design documents, firstly respectively all project design objects corresponding to one another from the project-specific project design document and from the reference project design document can be compared using the comparison identification and the respective superior project design object can be selected as the system-specific project design object for the system-specific project design document or accepted therein. If there are then still gaps in the system-specific project design document, these can then be closed using further reference project design objects.

According to a further preferred refinement, in the system-specific project design document, a reference project design object is also accommodated for which, during the comparison, no corresponding project-specific project design object was ascertained. Expressed more simply, no corresponding standard exists for this reference project design object—for example, by establishment when carrying out the comparison—so that this reference project design object from the reference project design document is accepted in the system-specific project design document.

In particular in this way, specifications—lying outside the standard—of a method producer may be considered.

Furthermore, it can also be provided here that when accommodating this reference project design object in the system-specific project design document, an adaptation of this reference project design object is performed.

For example, if such a reference project design object to be accommodated does not correspond to a higher-order project design philosophy, a corresponding transformation can be performed by this adaptation.

Data Structure and Transformation into Specific Representation.

It can preferably also be provided that the project-specific project design document and the reference project design document have the same, analyzable (data) structure—for the comparison according to the invention;—or are transformed into such a (data) structure—for the comparison—in particular from a representable, system-specific representation (transformation into representation capable of comparison and in the form of data).

During the comparison, respectively corresponding project design objects to be compared can then—very simply, because identical analyzable (data) structures are present in the project-specific and the reference project design documents—be ascertained or recognized from the project-specific project design document and from the reference project design document.

It can also be recognized in this way where no corresponding project design objects of project-specific and reference project design documents are present or provided. Expressed briefly in simplified form, it is recognized where the reference goes beyond the standard.

The analyzable (data) structure can particularly preferably be prepared or present in the form of a list. In such a list, parameter values for the (project-specific/reference) project design objects can also be stored.

Expressed in simplified form, respective corresponding lists respectively having all project design objects—and optionally further parameters—are prepared for the project-specific project design document and the reference project design document (representations capable of comparison and in the form of data)—and these lists are compared.

In particular, a data loss during the transformation into the comparable structures of project-specific and reference project design documents can be avoided via such lists.

During the comparison, such a list can then again be generated, i.e., a system-specific project design list, having corresponding (data) structure, which then represents the system-specific project design document having the system-specific project design objects.

Transformation into System-Specific Representation

Preferably, it can also be provided that the prepared system-specific project design document having the system-specific project design objects is (again) transformed (back) into a specific representation including a design of the control system of the technical system.

Expressed in illustrative or simplified form, where firstly for the comparison, the project-specific or reference project design document was transformed from the system-specific, representable representation into the representation which can be compared and is in the form of data, after the comparison, the prepared system-specific project design list can be transformed (back) again into the system-specific representable representation.

Usage in Control Technology

Furthermore, it is preferably provided that the prepared system-specific project design document is used or employed for the control technology to be project-designed of the system, in particular for the power plant control technology to be project-designed of the power plant, and/or the system, in particular the power plant, is controlled, regulated, and/or monitored using the prepared system-specific project design document.

For this purpose, in particular the system-specific project design document can be implemented or installed on a power plant control computer, to execute the control, regulation, and/or monitoring of the system or the power plant therein.

The description given up to this point of advantageous embodiments of the invention contains numerous features which are reproduced in the individual dependent claims, partially combined in multiples thereof. However, a person skilled in the art will also expediently consider these features individually and combine them to form reasonable further combinations.

In particular, these features are combinable each individually and in arbitrary suitable combination with the method according to the invention and/or with the device according to the respective independent claim.

### BRIEF DESCRIPTION OF THE DRAWINGS

An exemplary embodiment of the invention is illustrated in a FIGURE, and will be explained in greater detail hereafter.

In the FIGURE:

FIG. 1 shows an overview of a system for automatically generating system-specific project design documents, such as functional plans, for a power plant control technology according to one exemplary embodiment (ART-E).

### DETAILED DESCRIPTION OF INVENTION

Exemplary embodiment: system for automatically generating project design documents by maximum standards and system-specific comparison to reference plans (advanced rapid technology engineering [ART-E] 1).

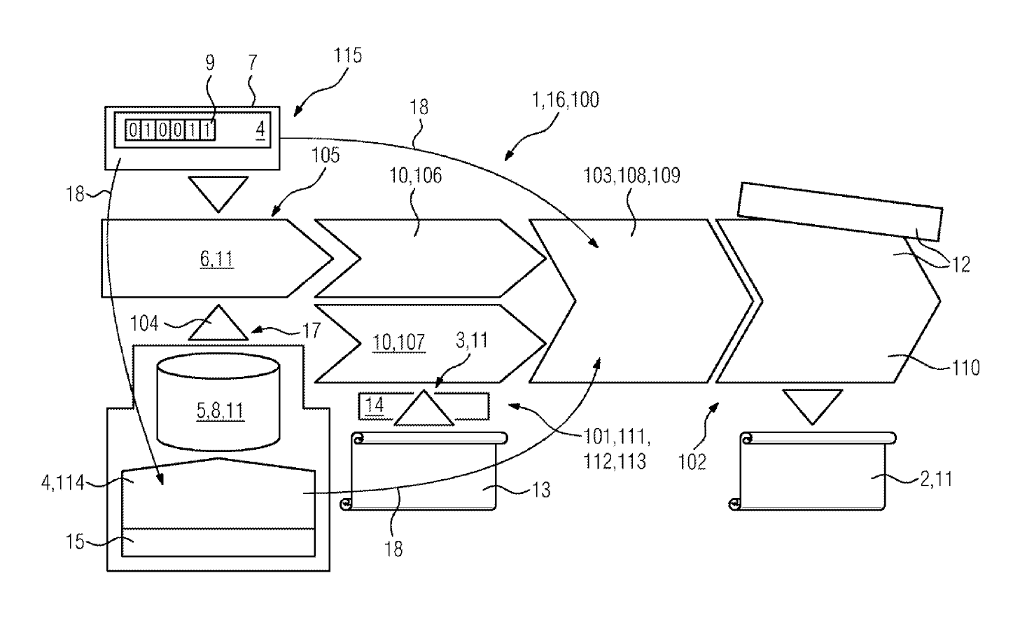

FIG. 1 shows an overview of a system 1—having its essential components, functions, and (functional) relationships—for automatically generating 100 project design documents 2, (system-specific) function plans 2 here, for a power plant control technology 100.

In this (project design) system 1, referred to hereafter in short as ART-E (advanced rapid technology engineering) 1, system-specific functional plans 2 are generated 100 by automatic comparison 103 of functional plans 6 generated 105 from standards 17, so-called project-specific functional plans 6, to reference functional plans 3.

Such reference functional plans 3 can be, for example, in the case of modernization projects of technical systems, functional plans of the control-technology old system or, in the case of new construction projects, functional specifications of the producer of the method system. ART-E is implemented in this case as software executable by a user on a programmable computing unit 16.

Standard Databank 8

ART-E 1 has, as FIG. 1 shows, a standard databank 8 as an essential component, in which a corresponding standard 17 is saved for each functional plan.

Each standard 17 is constructed in this case as a maximum variant, i.e., all possible functions which could be necessary in various (project design) projects are accommodated in this one standard 17.

Each functional plan 17 or each standard 17 is composed of (standard) project design objects 5 or (standard) functional plan elements 5, which are, for example, modules and/or connecting lines, graphic elements, or text/description modules.

Variant Definition/List 7

As FIG. 1 furthermore shows, ART-E 1 enables the preparation 115 of a specific description 7, a so-called variant definition list 7, in which it can be specified which specific construction of a method system to be project-designed (for example, boiler type of the power plant system, number of assemblies, inter alia) is present and which customer-specific requirements are to be fulfilled (for example, customer of the VGB market).

Identification 114 of Core Elements (Including Special Identification 15)

In the standard databank 8, as illustrated in FIG. 1, each (standard) functional plan element 5 is identified 114 (identification 4) as to whether this element must prevail for use in the (final) system-specific functional plan 2. Elements which are marked 4 so that they must prevail, i.e., that they are contained in the final system-specific functional plan 2, are referred to as core elements.

The identification 4 of a (standard) functional plan element 5 (as an element which is to prevail or is not to prevail) is not fixed in this case; rather, the possibility exists of linking the element identification 4 to rules from the variant definition list 7 (linkage 18).

Whether or not a standard functional plan element 5 must necessarily prevail for use on a final system-specific functional plan 2 can therefore be made dependent on the project-specific variant of the standard 17.

Furthermore, ART-E 1 provides a special identification 15, as FIG. 1 shows.

The identified core elements receive, wherever necessary, an additional special identification 15 if they fulfill a special function. For example, the functional modules or the ports of the corresponding functional modules are identified, which are activated with the setpoint value of a control loop.

This information is necessary to be able to carry out the comparison 103 to the reference plans 3—for example, in the case of comparison 103 of the setpoint value wiring—in a simple manner.

The identification of overall plans as a regulation plan or as a control plan is also associated with the special identification 15.

Degree of Comparison 4

As further illustrated in FIG. 1, a so-called degree of comparison 4 is specified in ART-E 1 via the variant definition list 7. The identification 4 of standard functional plan elements 5 as core elements can be influenced via this.

The degree of comparison 4 is expressed as a six-figure number in the binary system as illustrated in FIG. 1. Each digit of the binary number relates to a partial functionality 9 of a functional plan 2, 3, 6 in this case.

The following are considered separately as partial functionalities 9: regulating concept, setpoint value wiring, feedforward control, control concept, protective circuit, use of nonstandard measured variables.

A value of “0” for a partial functionality 9 means that, for the affected partial functionality 9, functional plan elements or structures are accepted from the standard functional plans 17 as final logics. In contrast, a value of “1” means that, for the affected partial functionality 9, the functional plan elements or the structures are accepted from the reference plans 3 as the final logics and the corresponding structures from the standard functional plans 17 are discarded.

The use of the degree of comparison 4 will be explained in greater detail on the basis of three examples:

A degree of comparison 4 of “000000” means that upon comparison 103, the functional plans 6 or their elements, which are generated from the standards 17, are accepted in their entirety as the final plans 2 or in the final plans 2, respectively. Expressed in illustrative form, no comparison is carried out, all functional plans 6 or their elements which are generated from the standards 17 are accepted in their entirety as the final plans 2.

The degree of comparison “111111” means that a complete comparison 103 is carried out. The reference plans 3 or their elements are accepted in their entirety as the final plans 2; the standard plans 17 or the functional plans 6 generated from the standards 17 are discarded.

In most cases, the degree of comparison 4 “010011” will be used. In the case of this degree of comparison 4, with mentioned partial functionalities 9, the regulating concept including the feedforward control as specified in standard 17 is implemented, however, the setpoint value wiring is accepted from the reference plans 3. The control concept is also implemented as predefined in the standard 17, but the protective circuit of the drives is accepted from the reference plans 3. If measured variables are used in the reference plans 3, which are not defined in the standard plans 17, the corresponding elements or partial structures are accepted from the reference plans 3.

Generation 105 of Project-Specific Functional Plans 6

To generate 105 the project-specific functional plans 6, in the case of ART-E 1, as schematically illustrated in FIG. 1, those standard functional plan elements 5 are selected 104 from the standard databank 8 on the basis of the variant definition list 7, which are relevant for a system to be project-designed.

Furthermore, the selected standard functional plan elements 5 are then adapted in a project-specific manner based on the variant definition list 7 and the project-specific functional plans 6 are generated therefrom 105.

During the generation 105, the linkages of the identifications 4 for the core elements are also analyzed using the rules from the variant definition list 7. Either a standard functional plan element 5 has a fixed identification 4 or the identification 4 is established according to the specifications in the variant definition list 7.

In any case, the identification 4 including the special identification 15 is passed on to the corresponding (project-specific) functional plan element in the project-specific functional plan 6.

Transformation 106 of the Project-Specific Functional Plans 6 into a Representation 10 in the Form of Data

As FIG. 1 also shows, in the case of ART-E 1, the project-specific functional plans 6 generated from the standards 17, including the identifications 4, 15 of the functional plan elements, are transformed 106 into a representation 10 in the form of data.

I.e., a list 10 of all functional blocks and all connections of a project-specific functional plan 6 is prepared (representation 10 in the form of data) 106. All parameter values of the functional blocks are also stored in the list 10, so that no data loss results due to the transformation 106.

Generation 101 of the Reference Functional Plans 3

Reference functional plans 3 are available as paper templates 13—having a quality sufficient for digital image processing (scanning) 111. The automation functions (functional plan elements 11) of a (digital) control technology are represented in these “hard copy” reference functional plans 13.

The “hard copy” reference functional plans 13 are scanned 111, whereby a corresponding graphic file is generated. This graphic file generated by the scanning 111 is further processed with the aid of digital image recognition 112.

Firstly, interference/noise is removed—by corresponding digital (signal) filtering 113—whereby the actual useful information of the reference functional plan 3 is selected.

On the basis of a symbol library 14, the functional plan elements contained in the graphic, such as functional modules and their connections, are identified 112 and assigned 112 to a corresponding standard functional plan element 5. The assignment is performed in this case not only for the functional module itself, but rather also with respect to the items of information on the module ports.

Transformation 107 of the Reference Functional Plans 3 into the Representation 10 in the Form of Data

The items of information ascertained from the image recognition 112 with respect to the reference functional plan elements, i.e., the digitally prepared reference functional plans 3, are transformed 107, as shown in FIG. 1, into the same representation 10 in the form of data as the project-specific functional plans 6.

I.e., a corresponding list 10 of all functional blocks and all connections is also prepared 107 for the reference functional plans 3 (representation 10 in the form of data).

Automatic Comparasion 103

As is illustrated in FIG. 1, an automatic comparison 103 of the project-specific functional plans 6—generated 105 from the standards 17—to the reference functional plans 3 is carried out—at the level of the representations 10 in the form of data of the plans 3, 6.

The representations 10 in the form of data of the project-specific functional plans 6 and the reference functional plans 3 are automatically analyzed 108 in this case.

In the scope of this analysis 108, in consideration 18 of the identification 4, including the special identification 15, the core elements are ascertained 109 like the degree of comparison 4, which parts of the project-specific functional plans 6 generated 105 from the standards 17 and which parts of the reference functional plans 3 are contained in the final system-specific functional plans 2 (automatic comparison 103 between “project-specific standard” and “reference”).

Thus, those functional plan elements or functional modules are searched 109 out of the project-specific functional plans 6, which are identified as core elements (also in specific variants). These are assigned 109 to the final system-specific functional plan 2. The connections between these functional plan elements are produced in analogy to the standard 17.

If not all functional modules were identified as core elements in the project-specific functional plan 6, the resulting gaps are closed 109 with modules from the reference functional plan 3.

Depending on which degree of comparison 4 was predefined, the following steps are to be performed 103, 109 for this purpose:

Comparison of Regulation Concept

If this is a regulation plan, the complete reference plan 3 is accepted. The differentiation between regulation plan and control plan occurs via the special identification 15 of the standard plan 17.

Comparison of Setpoint Value Wiring

The setpoint value wiring is identified in the reference plan 3. Since the identification/name of the actual value is already known from the generation 104 of the standard plan 17 and the identification assignment 114 therein, firstly a search can be made for the actual value in the reference plan 3. The signal to which the actual value is compared is the setpoint value. The complete circuit for generating the setpoint value in the reference plan 3 is identified 109 and assigned to the final functional plan 109. All connecting lines within this circuit are produced again in analogy to the reference plan 3. The setpoint value signal is connected to all ports which were wired in the standard plan 17 or project-specific plan 6 with the setpoint value. It is known which module ports thereof are affected from the special identification 15 of the core elements.

Comparison of Feedforward Control

The feedforward control is identified 109 in the reference plan 3. The identification/name of the feedforward is already known from the generation 104 of the standard plan 17 and the identification assignment 114 therein. The complete circuit for processing the feedforward in the reference plan 3 is identified and assigned to the final functional plan 2.

A transformation 109 of the circuit is optionally carried out such that it can be unified with the standard plan 17. A control of the feedforward at the regulator output is transformed 109 for coupling in at the regulator input, for example. All corresponding connecting lines are produced in analogy to the reference plan 3. The signal thus ascertained is coupled in at a position provided for this purpose of the standard plan 17. It is known from the special identification 15 of the core elements which position can be used for this purpose.

Comparison of Control Concept

If this is a control plan, the complete reference plan 3 is accepted. The differentiation between regulation and control plans is performed via the special identification 15 of the standard plan 17.

Comparison of Protective Circuit

The protective circuit is identified in the reference plan 3. After all functional modules including the module ports have been assigned to a standard functional module, it is known which signals act as protective signals. The complete circuit for generating the corresponding protective signal in the reference plan 3 is identified and assigned 109 to the final functional plan 2. All connecting lines within this circuit are produced again in analogy to the reference plan 3. The protective signal is connected to the corresponding protective input of the functional module from the standard plan 17.

Comparison of the Use of Nonstandardized Measured Variables

Circuits which use nonstandardized measured variables are identified in reference plan 3. Since all identification/names used in the standard plan 17 are already known from the generation 104 of the standard plan 17 and the identification assignment 114 therein, the ascertainment of measured variables which are used in the reference plan 3 but not in the standard plan 17 is easily possible. The complete circuit for processing such a measured variable is identified 109 and assigned 109 to the final functional plan 2.

A transformation 109 of the circuit is optionally carried out such that it can be unified with the standard plan. A control of a feedforward at the regulator output is transformed 109, for example, for coupling in at the regulator input. All corresponding connecting lines are produced in analogy to the reference plan 3. The signal thus ascertained is coupled in at a position provided for this purpose of the standard plan 17. It is known from the special identification 15 of the core elements which position can be used for this purpose.

Preparation 102 of the System-Specific Functional Plans 2

Building on this, i.e., on this automatic comparison 103, as FIG. 1 shows, the final system-specific functional plans 2 are prepared 102.

The representations 10 in the form of data of the final system-specific functional plans 2 are transformed 110 into the specific representation 12 of the control system of the power plant.

Although the invention was illustrated and described in greater detail by the preferred exemplary embodiments, the invention is not thus restricted by the disclosed examples and other variations can be derived therefrom by a person skilled in the art, without leaving the scope of protection of the invention.

### LIST OF REFERENCE NUMERALS

1 (project design) system/device, advanced rapid technology engineering (ART-E)

2 system-specific project design document/functional plan

3 reference project design document/functional plan

4 comparison identification, identification, degree of comparison

5 standard project design objects, standard

6 project-specific project design document/functional plan

7 specific description, variant definition list

8 archive, standard databank

9 (partial) functionality

10 analyzable (data) structure, representation in the form of data, list

11 project design objects

12 specific representation including design

13 (paper) document

14 symbol library

15 special (comparison) identification

16 data processing device, programmed/programmable computing unit

17 standard, standard project design document/functional plan

18 use of (4), consideration, linkage

100 method for generating a system-specific project design document

101 generation of a reference project design document

102 preparation of a system-specific project design document

103 comparison to reference

104 selection from archive, generation of a standard project design document/functional plan

105 preparation of a project-specific project design document

106 transformation of the project-specific project design document/functional plan into representation in the form of data

107 transformation of the reference project design document/functional plan into representation in the form of data

108 analysis

109 comparison, selection, acceptance. Close gaps, adaptation, and/or transformation

110 transformation of the system-specific project design document/functional plan into specific representation

111 digital image processing, scanning

112 digital image recognition, analysis of digital image information, identification of functional plan elements, assignment of functional plan elements

113 filtering

114 identification

115 preparation of a variant definition list, preparation of a description.

1. A method for generating a system-specific project design document, for generating a system-specific functional plan, for a control technology to be project-designed for a technical system, the method comprising:
generating a reference project design document of the technical system,
preparing the system-specific project design document
by a comparison, which is carried out using a comparison identification of a project-specific project design document, which is prepared using standard project design objects, of the technical system to the reference project design document,
wherein during the comparison, the project-specific project design document is compared to the reference project design document and in this case on the basis of the comparison identification, a project design object is selected from the project-specific project design document or the reference project design document for the system-specific project design documents.

2. The method as claimed in claim 1, wherein the standard project design objects are selected using a specific description of the technical system from a plurality of predefined standard project design objects.

3. The method as claimed in claim 1, wherein the project-specific project design document is prepared using a specific description from the standard project design objects.

4. The method as claimed in at least one of the preceding claim 1, wherein the predefinable comparison identification describes a rank of a standard project design object and/or a rank of at least one functionality of the technical system.

5. The method as claimed in claim 4, wherein the rank of the standard project design object and/or the rank of the functionality is/are dependent on a project-specific variant of the technical system, and/or wherein the functionality is a regulating concept, a setpoint value wiring, a feedforward control, a control concept, a protective circuit, and/or a use of nonstandardized measured variables.

6. The method as claimed in claim 1, wherein the project-specific project design document and the reference project design document have the same analyzable data structure or are transformed therein, wherein during the comparison, with analysis of this analyzable data structure, in each case corresponding project design objects are ascertained from the project-specific project design document and from the reference project design document.

7. The method as claimed in claim 1, wherein during the comparison, respective project design objects corresponding to one another from the project-specific project design document and from the reference project design document are compared using the comparison identification, and the respective project design object identified as superior is selected for the system-specific project design document, and/or wherein during the comparison, firstly project design objects identified as superior from the project-specific project design document are accepted in the system-specific project design document and subsequently gaps in the system-specific project design document are closed by project design objects from the reference project design document.

8. The method as claimed in claim 6, wherein, in the system-specific project design document, a project design object from the reference project design document is also accommodated for which, during the comparison, no corresponding project design object from the project-specific project design document was ascertained, and wherein, during the accommodation of this project design object in the system-specific project design document, it is adapted.

9. The method as claimed in claim 6, wherein the system-specific project design document also has the same analyzable data structure as the project-specific project design document and the reference project design document and/or the system-specific project design document is transformed from this analyzable data structure into a specific representation of the control system of the technical system.

10. The method as claimed in claim 1, wherein the reference project design document is prepared by digital image processing of a predefined document, and/or wherein the reference project design document is prepared by analyzing digital image information, including by analyzing the predefined document processed by digital image processing, wherein during the analysis, the reference project design document is prepared in an analyzable data structure.

11. The method as claimed in claim 10, wherein the digitally image-processed reference project design document is filtered and/or wherein the analysis of the digital image information, including the analysis of the predefined document processed by digital image processing, is performed using a symbol library, wherein the reference project design document is prepared in an analyzable data structure, during the analysis.

12. The method as claimed in claim 1, wherein a project design document has project design objects, and/or wherein a project design document is a functional plan, and/or wherein a project design object of a project design document is a functional plan object, having a functional module, a connection, a text, a description, or a name.

13. The method as claimed in claim 1, wherein a project design object of the project-specific project design document, which has a defined predefinable comparison identification after the comparison identification, is additionally described with a special comparison identification and the comparison is performed also using this special comparison identification.

14. A device for generating a system-specific project design document, for generating a system-specific functional plan for a control technology to be project-designed of a technical system, comprising
a data processing device which is configured for:
generating a reference project design document of the technical system,
preparing the system-specific project design document,
by a comparison, which is carried out using a comparison identification, of a project-specific project design document, which is prepared using standard project design objects, of the technical system to the reference project design document, wherein during the comparison, the project-specific project design document is compared to the reference project design document and in this case on the basis of the comparison identification, a project design object is selected from the project-specific project design document or the reference project design document for the system-specific project design document.

15. A method for generating a system-specific project design document, comprising:
generating the system-specific project design document according to the device of claim 14 for the control technology to be project-designed of the technical system, for a power plant control technology of a power plant.

16. The method as claimed in claim 2 wherein the predefined standard project design objects are stored in an archive.

17. The method as claimed in claim 4 wherein the rank is a superiority.

18. The method as claimed in claim 10 wherein the reference project design document is prepared by scanning or image recognition.

19. The method as claimed in claim 14 wherein the data processing device is a programmed computing unit.
